(19) United States
(12) Patent Application Publication
(10) Pub. No.: US 2024/0068597 A1
(43) Pub. Date: Feb. 29, 2024

(54) Multiple Pipe Borehole Installation Device, Method, and System

(71) Applicant: BCM Hill Top Holdings, LLC, Victoria, TX (US)

(72) Inventors: Michael Lee Drewett, Montgomery, TX (US); Brian Christopher Morris, Victoria, TX (US)

(21) Appl. No.: 18/454,490

(22) Filed: Aug. 23, 2023

Related U.S. Application Data
(60) Provisional application No. 63/401,076, filed on Aug. 25, 2022.

(51) Int. Cl. F16L 1/11

(52) U.S. Cl. CPC F16L 1/11

(57) ABSTRACT

The present invention addresses problems in the installation of multiple pipes through a single borehole at the same time. Attempting such an installation causes pipes to clash and rub. With multiple pipes being installed in a single borehole, in some cases, there will be multiple pipes crossing a single roller right before entering the borehole, increasing the chances of damage to the bumper/spacer and to pipe. This action causes safety issues for people, the environment, endangered species, and other wildlife, at an installation site. In at least one example, bumpers are applied to the pipes such that the chance of damage is reduced while also reducing risk to people and the environment.

### RELATED APPLICATIONS

This application claims priority to U.S. Provisional Application No. 63/401,076, filed on Aug. 25, 2023, incorporated herein by reference for all purposes.

### BACKGROUND

The present invention addresses problems in the installation of multiple pipes through a single borehole at the same time. Traditionally, attempting such an installation caused pipes to clash and rub. With multiple pipes being installed in a single borehole, in some cases, there will be multiple pipes crossing a single roller right before entering the borehole, increasing the chances of damage to a bumper/spacer and to pipe. This action causes safety issues for people, endangered species, and other wildlife, at an installation site. For example, there is a high risk of bodily injury or even death should the pipes fall from roller structures used to guide the pipes toward the borehole. Also, degrading occurs of important coatings for protection. Since many such installations are of pipes through which volatile and explosive hydrocarbons pass (e.g., natural gas, diesel fuel, gasoline, jet fuel, and others), not only are the lives and health of people and animals near the installed pipes at risk, but climate change and other environmental damage will occur due to failure of the pipes. Specific areas in which this problem exists include the so-called Horizontal Directional Drilling techniques, where bundles of pipe are being pulled through a single bore.

Specifically, pipe coating keeps the pipe from rusting and deteriorating. When pipe deteriorates, pipelines fail, causing an environmental disaster that can destroy precious land and endanger or even kill people and wildlife. Ideally, a pipe being installed with other pipes should not touch any other piece of pipe while being pulled through the single bore. If touching happens, the chance of pipeline failure increases. A further problem occurs because, traditionally, the pipes must be pulled through a series of roller stands and or cradle roller slings as they approach the bore. Disturbance during this part of the process also damages coatings and causes pipes to violently clash.

There is a long-felt, but unsolved, need to address these severe problems, which are currently recognized, as evidenced by past, failed attempts at using bumpers installed on pipe. They were to serve as spacers to keep distance between pipes that were being installed together. However, traditional bumpers get hung up in the roller stands and/or the cradle roller slings. When this happens, it causes the pipe to wildly jump or bounce. That creates an extremely dangerous safety hazard in which people can be seriously injured or even killed.

Also, such bumpers are cumbersome. For example, they traditionally have a 1″ radial standoff without a taper that hangs on roller stands or cradle roller slings. In typical traditional installations, a rubber ring is placed on the pipe; then, duct tape is wrapped around the rubber ring. Once the rubber ring is in place, a bonding agent/epoxy is applied to the outside of the pipe—roughly 6 inches on either side of the rubber ring. Once the bonding agent/epoxy is in place, a heat shrink tube is pulled over the rubber ring and bonding agent/epoxy. Then a technician uses a torch to heat the shrink tube until it is tight around the rubber ring and the bonding agent/epoxy.

Bumper use of this type creates drag on the pipe as the bundle is being pulled through the bore. The rubber ring does not efficiently pass through the bore, causing the rings to be ripped off. This, in turn, causes pipes in the bundles to contact each other. This contact can and will damage the integrity of the pipe coating, which is instrumental in keeping the pipe from degrading.

Also, previous systems for bumpers/spacers, require an excavator or similar equipment to be present for when the prior bumpers hang in roller cradles and slings. For example, rubber rings hinder the pipes' ability to pass through roller stands and cradle roller slings safely. Once a rubber ring hits a roller stand or cradle roller sling, it hangs up and causes pipe to bounce. The only way currently-known to avoid this “bounce” is to have an extra piece of equipment (normally a rented excavator) on site to lift the pipe as the rubber ring approaches the roller stand or cradle roller slings and hold it up until the rubber ring is past. This is costly, dangerous, contributes to greenhouse gases, and is an environmental hazard; further it is not trivial, the equipment normally is used at each roller stand and cradle roller sling station. They are normally every 30-40 feet. The transport and operation of this equipment further creates CO2 and other greenhouse gas emissions, as well as air pollution and safety issues for people at the site of installation.

Further, traditional bumpers also need a propane-fueled torch to install the bumper with shrink wrap. This causes many problems. For example, propane is a burning hydrocarbon, contributing to climate change. Elimination of the propane torch installation could eliminate propane emissions from as many as 500,000 installations per year, in the United States alone, or more. Also, the need for a torch installation further increases the danger to the workers operating or handling the torch equipment. Further, if the heat of installation is too hot, it will damage the integrity of the pipe coating—causing a possible pipeline failure. Further still, with bumpers constructed with heat-shrink-covered rubber rings, the heat-shrink will peal back, and the rings will move or be lost.

There is a severe need to address the above problems.

### SUMMARY OF EXAMPLE EMBODIMENTS

According to one aspect of the invention, systems, devices, and methods, are provided for installing multiple pipes in a final ground position. Pipes, in various examples comprise a variety of sizes—sometimes the same size and sometimes different. In some examples, the final ground position consists essentially of a borehole.

According to a further aspect of the invention, a process is provided for installing multiple pipes in a borehole, the process comprising: installing a straight-tapered bumper element around a first pipe; pulling the first pipe and a second pipe passed a pipe roller, the tapered bumper element preventing the first and second pipes from touching during the pulling; and preventing bouncing of pipes in the pipe roller with the taper.

According to another aspect, a system is provided for installing multiple pipes in a borehole, the system comprising: means for installing a straight-tapered bumper element around a first pipe; means for pulling the first pipe and a second pipe passed a pipe roller, the tapered bumper element preventing the first and second pipes from touching during the pulling; and means for preventing bouncing of pipes in the pipe roller with the taper. In at least one such system, the means for installing a straight-tapered bumper element comprises: bands applying a radial force against bumper elements disposed opposite each other on a pipe and bonding agent positioned between the bumper elements and the pipe. In a further such system, the mains for pulling the first pipe and the second pipe comprises a horizontal directional drilling system.

According to another aspect of the invention, bumpers such as those described in examples of the invention are quickly and easily installed. Such processes result in a longer bumper in the axial direction, having a large surface contact with the pipe. While contrary to previous processes of using bumpers with a short axial length, having a longer axial contact with the pipe allows for increased strength of bonding the bumper to the pipe without the use of propane to enable heat-shrink installation, while still maintaining a bumper attachment with no metal. Use of metal in an application where pipes are installed in parallel or used in parallel allows for cathodic degradation.

According to another aspect of the invention, at least one unexpected advantage of the is ability to install a bumper system quickly. This was achieved, in part, by use of an electric adhesive applicator gun with adhesives, eliminating the need for a torch to address heat shrink.

According to at least one example, a tapered Spacer Bumper Element (“SBE”) is installed on at least one of the pipes to prevent them from touching, giving protection from damage that may be caused to pipes (or coatings of pipes, when present) from the touching. For example, in at least one system the initial standoff of about 0.13 inches, which is almost a 10th of traditional bumpers. In this example, the bumper tapers along the pipe over a 10″ length to a 1″ standoff and then tapers back down for a 10″ length to another 0.13 standoff. Radial shock smoothing by a tapered shape allows the bullet-shaped bumper to safely and easily pass through roller stands and cradle roller slings. In at least one example, the taper between the initial standoff and the largest standoff is straight. In a straight-taper system, rather than a curved taper, the loading of the bumper and the roller cradle is surprisingly smoother than with a curved taper, which occurs when heat-shrink is used. As used in this document, “bullet-shaped” should be interpreted to mean a tapered bumper/spacer with a straight taper.

In some examples, a means for scuffing the surface of a pipe (e.g., sandpaper is used to scuff the surface before application of an adhesive. In further examples, a means for cleaning (for example, methyl-ethyl-ketone) is applied to the surface of the pipe (for example, after the scuffing).

In some examples, a SBE (which included tapered ends in some cases) is installed by using a two-part adhesive gun to squirt adhesive out of multiple cartridges through a single nozzle throughout an inner arc of a first SBE component and a second SBE component. In some such examples, a means for smoothing adhesive (for example, a putty knife) evenly spreads adhesive throughout the inner arc of the SBE components.

Acrylic adhesives (e.g., 3M DP87NS paired with specific surface preparation methods described in this document are surprisingly strong, reducing the chance of damage, and loss of life.

In further examples, the SBM components are positioned around a pipe, radially opposed to each other with respect to the pipe. In some such examples, a set of binding straps are placed in channels in the SBE components such that the SBE components are positioned substantially radially-opposite the pipe. The above is an example of a means for positioning, under radial pressure, the first SBE component and the second SBE component substantially opposed around one of the pipes.

In at least one example, more than two pipes are simultaneously installed. In some such examples, each pipe includes at least one two-piece SBE and is pulled into a borehole by a means for pulling multiple pipes through a borehole (e.g., a horizontal directional drilling rig). In some further examples, the pipes are pulled passed rollers that are located, in some examples, in a separate stand roller system and/or a roller cradle sling. Examples using tapered ends of SBEs reduce opportunities for pipes to hang up on the rollers; the hanging would cause dangerous conditions where too much force is applied to the stand roller system or cradle sling.

In one further example, the stand roller system is positioned next to borehole. In an alternative example, a roller cradle sling is positioned between a stand roller system and a borehole.

The means for pulling (and equivalents) described above are one example of a means for installing multiple pipes. Another includes an excavator, used to lay pipes into a ditch. Other examples of equipment sufficient as a means for installing includes cranes and backhoes. In further examples, more than two pipes are installed into the ground; in still further examples, all pipes include SBEs. In other examples less than all include SBEs. The number of SBEs will vary with the specific application when considering the goal of reducing contact between pipes, after installation, to avoid coating and/or pipe damage.

In still a further example, an SBE has a circular inner arc (also referred to as a “SCIA”) of less than 180 degrees, a first straight-tapered end and a second straight-tapered end. In some such examples, a second SBE has substantially the same circular arc as the first SBE and is less than 180 degrees in arc.

In some examples, when the first and second SBEs are positioned radially-opposite each other on the circular arc, the SBEs will not touch, at least on one side. In some such examples, they do not touch on either side. In some alternative examples, the SBEs are connected (e.g., by a hinge) but still do not touch on both sides when positioned along the arc. Reduction of touching along the sides of the SBE components allows radial force to be applied during installation to increase bonding to the pipe by a bonding agent (sometimes referred to as an adhesive) applied to the inner surfaces of the components.

In many examples, means are also provided for positioning, under radial pressure, the first SBE and the second SBE around a pipe, substantially opposed to each other. In at least one example, the means for positioning comprises a set of straps or bands. In many such examples, the means for positioning is applied at substantially ambient temperature, avoiding undesirable shrink wrap, which tends to peel and clog rollers and boreholes in narrow environments. Ambient-air positioning also avoids risk to the pipe that may be caused by application of heat to a shrink-wrap or other heated positioner. In at least one such example, the bands do not axially extend beyond SBE examples with straight-tapered-ends, and the bands are positioned and arranged to exert a radial force on the SBE that is less than the minimum bending force of either the first or the second SBE components. This reduces the chance that tapered ends of the SBE components will creep up, which would cause binding and damage to the SBE in close environments.

In some such examples, bands limit axial movement of an SBE by being constrained in channels that are molded into the SBEs. In other examples, the constraint comprises other ridges, tapers, or other structures that restrain a means for positioning from axial slippage such that the bands hold SBE components against a pipe (106a) as a bonding agent cures to the pipe surface and/or surface coating. In at least one example, the bonding agent is applied to substantially all the interior surface of at least one of the first SBE component and second SBE component. In some examples, the bonding agent comprises a polyurethane of hardness 90 Shore A.

Although specific advantages have been in this document, various embodiments may not include some or any of the enumerated advantages, and other technical advantages may become readily apparent to one of ordinary skill in the art after review of the following figures and description. Exemplary embodiments are illustrated in the figures and described in this document, and the principles of the present disclosure may be implemented using many techniques. The examples are not intended to limit the scope of the claims recited in this document or as amended in prosecution, unless a clear limitation is recited as applying to all claims.

Further, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Unless otherwise specifically noted, articles depicted in the drawings are not necessarily drawn to scale.

### BRIEF DESCRIPTION OF THE DRAWINGS

FIG. 1 is a perspective view of an aspect of the invention.

FIG. 2A is a perspective view of an aspect of the invention.

FIG. 2B is a perspective view of an aspect of the invention.

FIG. 2C is a perspective view of an aspect of the invention.

FIG. 2D is a perspective view of an aspect of the invention.

FIG. 3A is a perspective view of an aspect of the invention.

FIG. 3B is a perspective view of an aspect of the invention.

FIG. 4 is a perspective view of an aspect of the invention.

FIG. 5 is a perspective view of an aspect of the invention.

FIG. 6 is a perspective view of an aspect of the invention.

FIG. 7A is a perspective view of an aspect of the invention.

FIG. 7B is a perspective view of an aspect of the invention.

### DETAILED DESCRIPTION OF THE EXAMPLE EMBODIMENTS

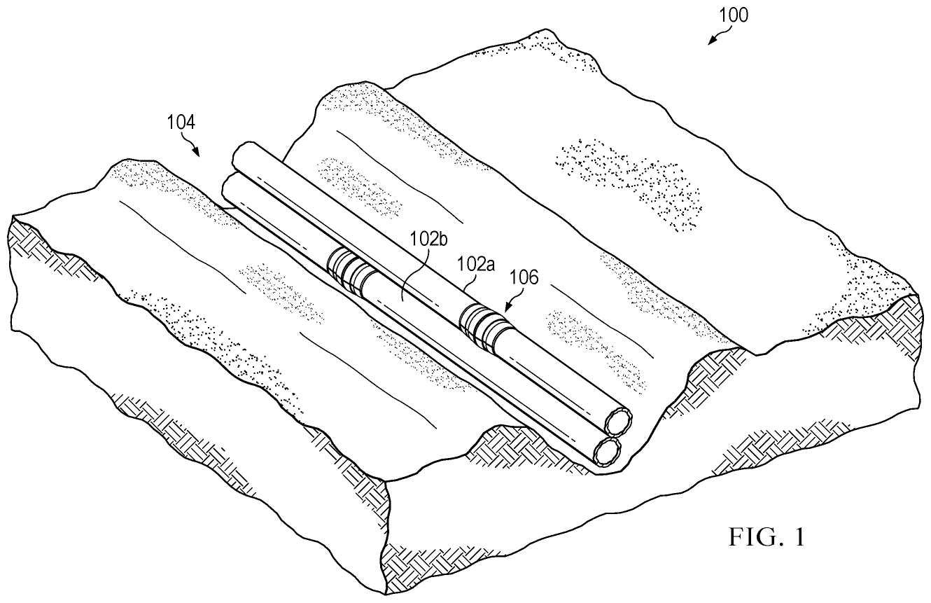

Referring now to FIG. 1, an example of an aspect of the invention is seen. As shown, a system 100 is provided for installing multiple pipes (102a and 102b) in a final ground position (in the illustrated example, at ditch (104)). Pipes (102a and 102b) in various examples comprise a variety of sizes—sometimes the same size and sometimes different. There is no particular size limitation to the pipes as used with the present invention in that any that would normally be installed in the applications described are useful with the present invention.

In some examples, the final ground position consists essentially of a borehole (illustrated later). In FIG. 1, a tapered Spacer Bumper Element (“SBE”) (106) (sometimes referred to herein as “bullet-shaped bumper elements”) is seen, which prevents the pipes from touching, giving protection from damage that may be caused to pipes (or coatings of pipes, when present). The SBE (also sometimes called a “Bullet Bumber”), is seen installed around first pipe (102a).

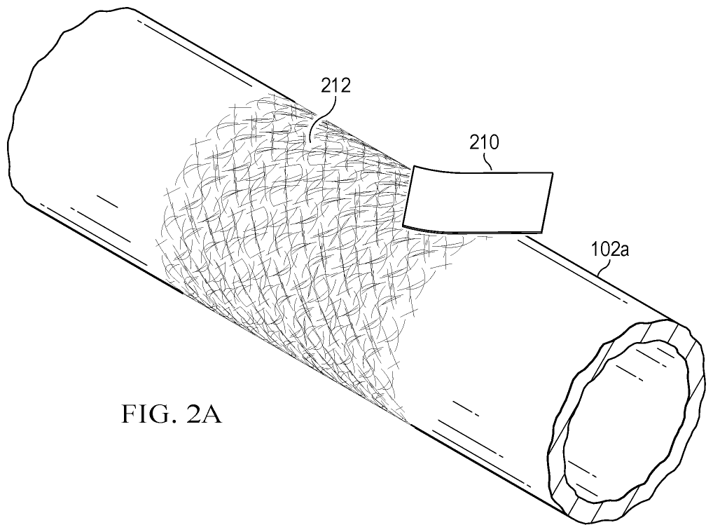

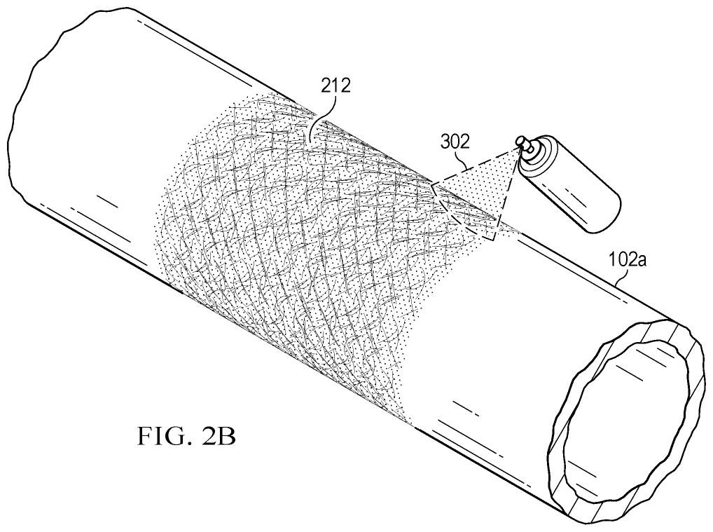

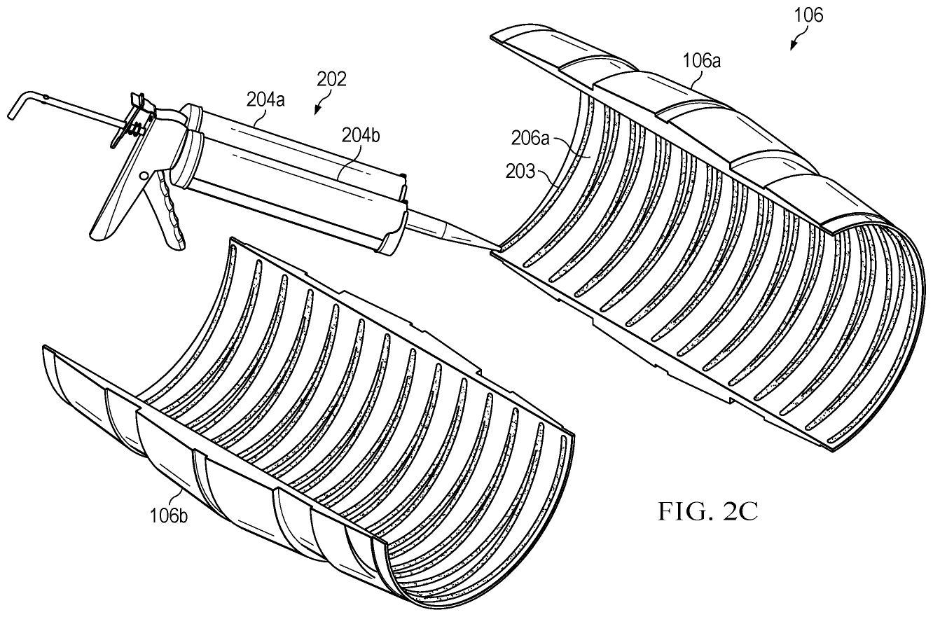

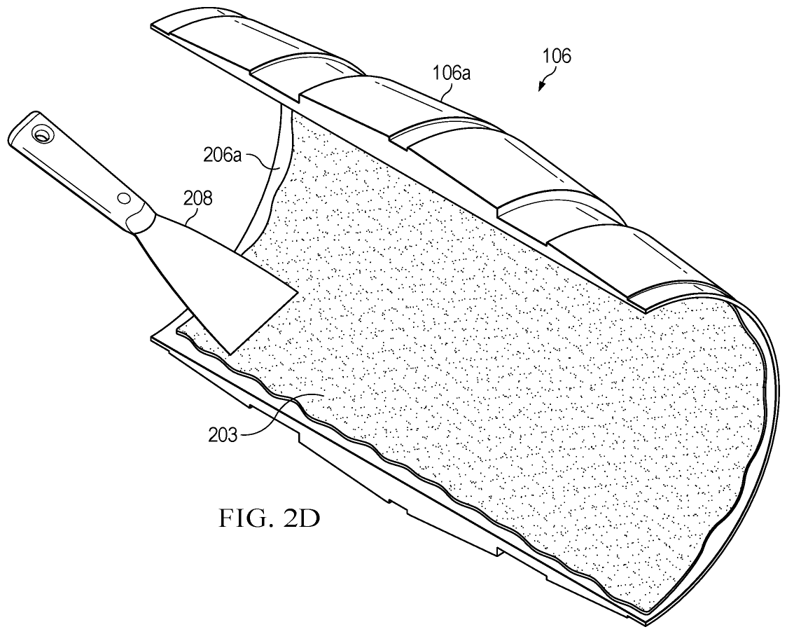

Referring now to FIG. 2A, sandpaper (210) (e.g., 80 grit) is used to scuff the surface (212) of pipe (102a) before application of an adhesive (203). The type of adhesive depends on the type of pipe or pipe coating used. One surprising result, obtained during testing, was the strength of the bond between the inventive bumper and the pipe at 2750 psi. This is obtained because of the specific preparation of the pipe coating surface and surface treatment of the inside wall of each element of the bullet-shaped bumper invention. This specific preparation is described elsewhere in this document. Other adhesives will occur to those of skill in the art without further elaboration.

In FIG. 2B, cleaner (302) (for example, “MEK” (aka, methyl-ethyl-ketone) is applied to the scuffed surface (212) of the pipe (102a). The type of cleaner depends on the type of pipe or pipe coating used. Other cleaners will occur to those of skill in the art without further elaboration.

In some examples, the cleaner is applied with a spray as shown. In alternative examples, a rag or other application device that will occur to those of ordinary skill is used.

In FIG. 2C, the tapered SBE (106) is installed, in at least one example, by using a two-part adhesive gun (202) to squirt adhesive (203) out of a cartridges (204a and 204b) through a nozzle onto an inner arc (206a) of a first SBE component (106a) and a second SBE component (106b). The type of applicator depends on the type of adhesive used. Other applicators will occur to those of skill in the art without further elaboration.

As seen in FIG. 2D, a smoother (208) (for example a putty knife) evenly spreads adhesive (203) (throughout the inner arc (206a)) of the SBE components. The materials used in at least one example comprise:
2 bullet-shaped bumper elements cast from Andur 9200AP or equivalent such as Polycoat 60-90 or Chemline PT930
3m adhesive DP6310NS
Heavy duty zip ties—5 pcs per bumper
Shop Towels
Klean Strip MEK substitute 1 qt can
Plastic putty spreader/scraper
80 grit strip of sandpaper 18-20″ long
Zip tie gun.

In some examples, the following steps are performed to cast bullet-shaped bumper elements:

1. The prepolymer Andur 9200 AP, or equivalent such as Polycoat 60-90 or Chemline PT930 is heated to a workable viscosity in an oven. Prepolymer temperature should be in the range of 158-220 deg F. Overheat the prepolymer is to be avoided.

2. For each bullet-shaped bumper size use the weights and percentages listed below:

| Bumper | | | | | | |
|---|---|---|---|---|---|---|
| size | Curative | Pounds | Percentage | Prepolymer | Pounds | Percentage |
| 4.5″ | Curene 442 | 1#s | 18% | Andur 9200 AP | 5#s | 82% |
| 6″ | Curene 442 | 2#s | 18% | Andur 9200 AP | 10#s | 82% |
| 8″ | Curene 442 | 2.5#s | 18% | Andur 9200 AP | 12.5#s | 82% |
| 10″ | Curene 442 | 3.2#s | 18% | Andur 9200 AP | 16#s | 82% |

Prepolymer (e.g., Andur 9200AP or equivalent such as Polycoat 60-90 or Chemline PT930 is loaded into a heated tank set between 158-220 deg F. Next, curative (Curene 442) is loaded into a heated tank set at 240 deg F. Once both have a working viscosity, the Andur 9200AP or equivalent weight is measured out, as is the set weight of the Curene 442. Next, the two are mixed thoroughly. Because the mixture has a short working life (approximately 3.5 min), once mixed, the mixture is slowly poured into a two-part bullet-shaped bumper (for example, using a sheet metal mold that has been sprayed with mold release material that will occur to those of skill in the art) filling it to the top. After being allowed to sit and set up for 15-20 mins, the top portion of the mold is raised and set aside, and the bullet-shaped bumper element is removed from the lower portion of the mold.

The bullet-shaped bumper element is then heated in an oven set to 212 deg F for 16 hours, which is sufficient to achieve a full cure.

Various examples of the invention are useful in ambient temperatures between about −26 F to about 220 F.

In at least one example, a process is provided for installation of a bumper on a pipe. The process comprising:

1: Set element on pipe and mark both ends with a paint pen or marker. This mark should be based on the spacing requirements for the specific job.

2: Use an 80-grit strip of sandpaper to abrade the surface of the pipe coating. This helps to ensure a sound bond between the pipe coating and bumper elements.

3: Wipe any dust off of sanded pipe with a dry towel or shop rag.

4: Loosely attach 5 zip ties to pipe without tightening. Tighten these later one the bumper elements are both in place.

5: Spray pipe with MEK substitute (e.g., from Klean Strip) heavily, then spray it again and immediately wipe with clean, dry towel or shop rag. Spray inner portion of bumper element with MEK substitute, then spray again and immediately wipe with dry towel or shop rag. This is to remove dirt, grease and grime; it provides for a sound bond between the pipe coating and the bumper element.

6: Apply adhesive (e.g., 3M adhesive DP8710NS) using an electric gun with a static mix nozzle to the inner surface of the bumper element which has been previously sandblasted to create a rough surface (the rough surface is required so that you can achieve a sound bond) and spread evenly with a plastic putty scraper/spreader. The adhesive has a 10 min working life at 75 deg F.

7: Place both bumper elements onto treated area of pipe and apply zip ties in 5 recessed places.

8: Hand-tighten the zip ties then use zip tie gun to maximize the tension. Allow the part to sit for 24 hours to achieve a full cure.

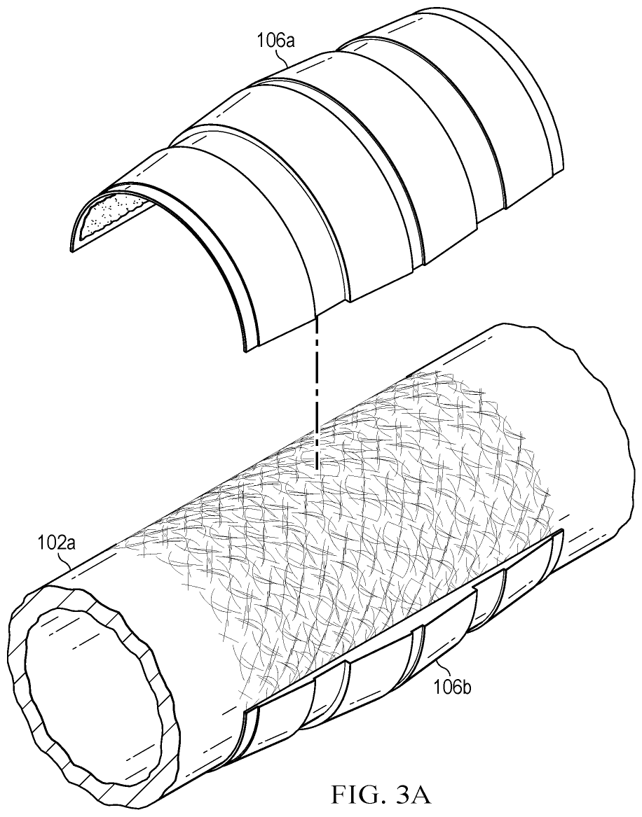

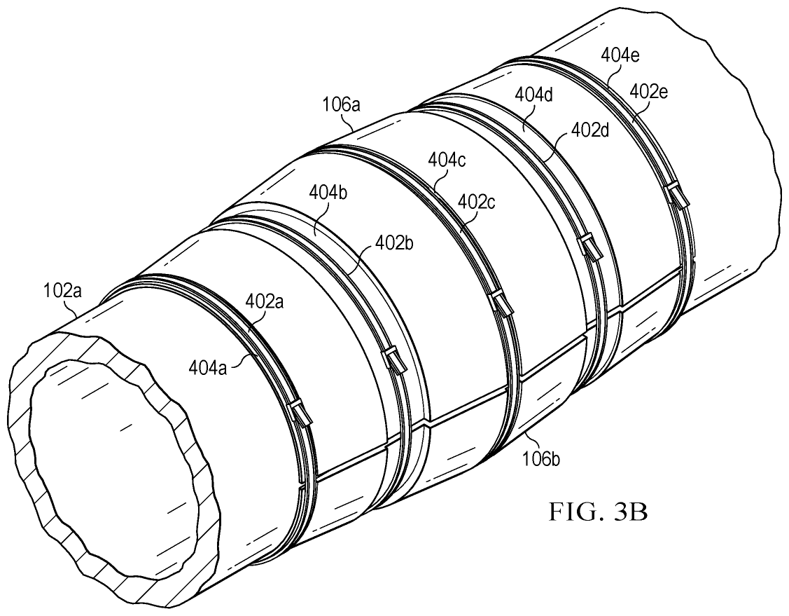

As seen in FIG. 3A, an example is seen in which the SBM components (106a) and (106b) are positioned around pipe (102a), radially opposed to each other with respect to pipe (102a). In FIG. 3B and a set of binding straps 402a-402f (e.g., zip-ties) are placed in channels (404a-404f) in the SBE components (106a) and (106b), such that the SBE components (106a) and (106b) are positioned substantially radially-opposite the pipe (102a). The above is an example of a means for positioning, under radial pressure, the first SBE component and the second SBE component substantially opposed around one of the pipes. Equivalent means for positioning will occur to those of skill in the art without further elaboration.

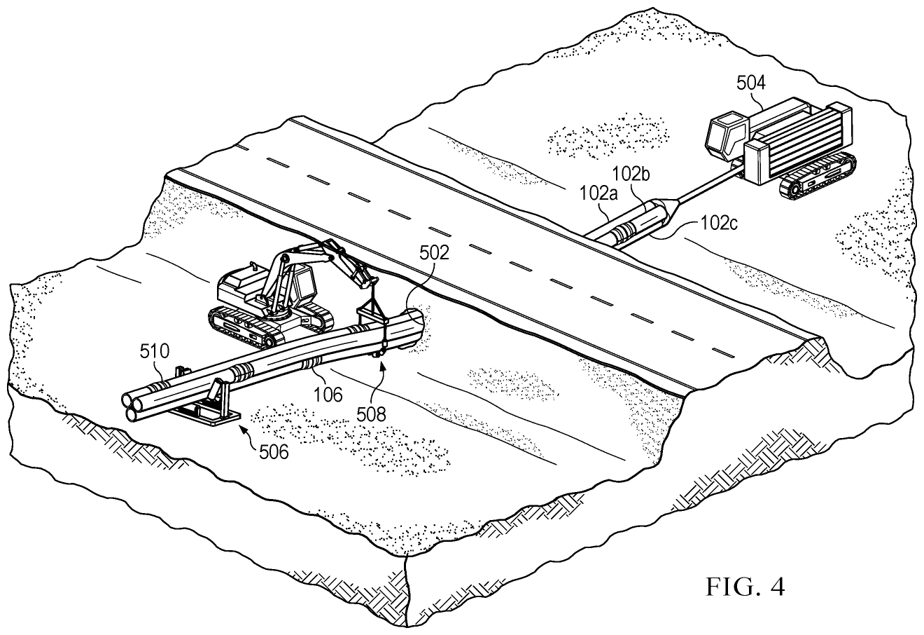

As seen in FIG. 4, in at least one example, and example is seen in which more than two pipes are simultaneously installed (in the illustration, three: (102a, 102b, and 102c)). In this example, each pipe includes at least one two-piece SBE (106), is pulled into borehole (502) by an HDD (Horizontal Directional Drilling) rig (504). As seen, pipes (102a-102c) are pulled passed rollers (504a-504x) located in some examples, in a separate stand roller system (506) and/or a roller cradle sling (508). Stand roller system (506) and roller cradle sling (508) are of a type known to those of skill in the art. Equivalent roller systems will occur to such individuals without further elaboration. Tapered ends (510) of the SBE prevent pipes (102a-102c) from hanging on the rollers; the hanging would cause dangerous conditions where too much force is applied to the stand roller system (506) or cradle sling (508).

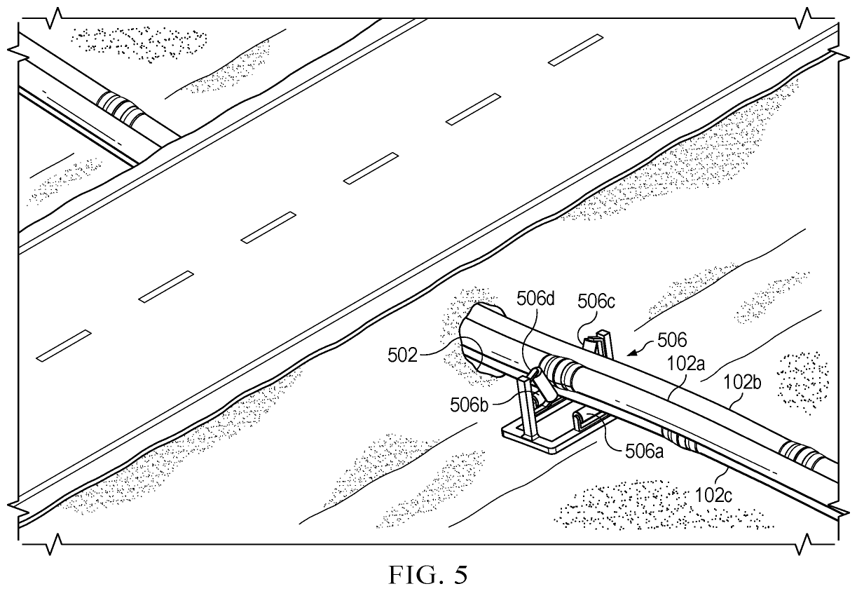

In FIG. 5, an alternative example is seen, in which stand roller system (506) is used, next to borehole (502), rather than using a roller cradle sling between stand roller system (506) and borehole (502).

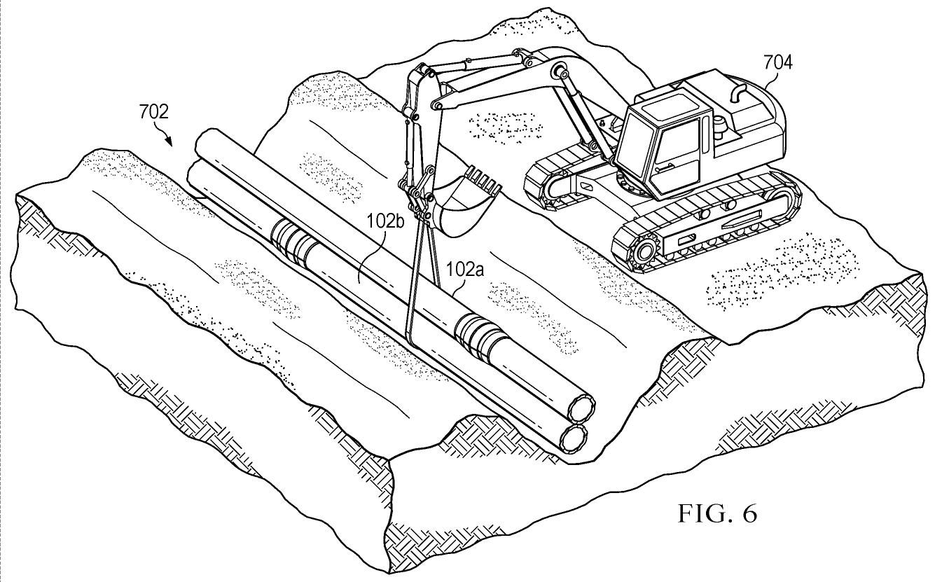

In the example of FIG. 6, pipes (102a) and (102b) are seen being laid into a ditch (702) by an excavator (704). Other examples of equipment for such installation includes cranes, backhoes, and other equipment, which will occur to those of skill in the art without further elaboration. In further examples, more than two pipes are installed into the ground; in still further examples, all pipes include SBEs, or only some. The number of SBEs will vary with the specific application when considering the goal of reducing contact between pipes, after installation, to avoid coating and/or pipe damage.

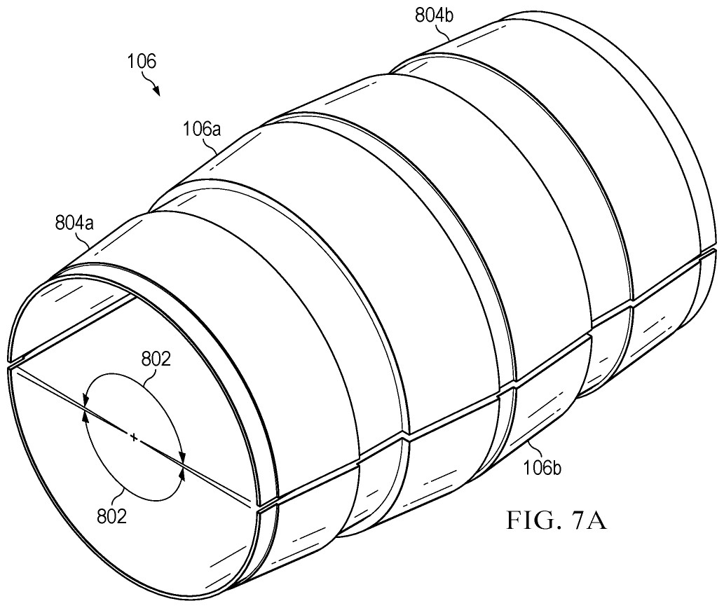

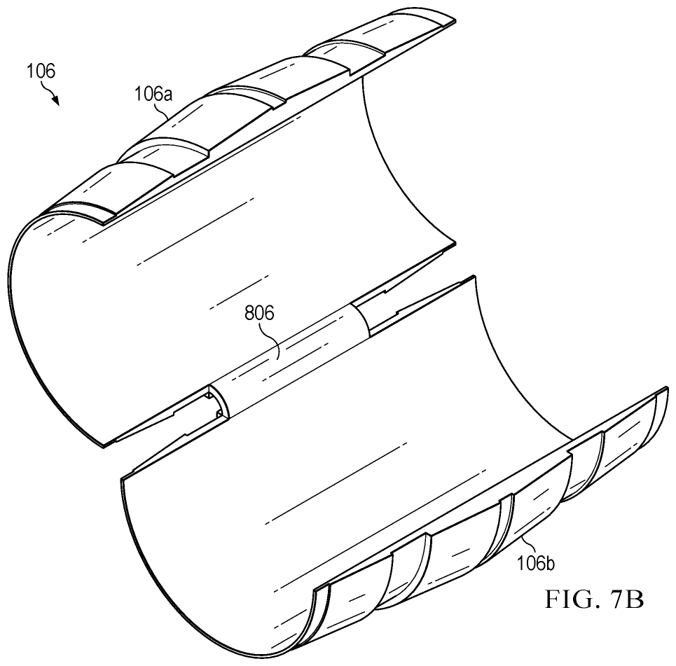

Referring now to FIG. 7A, a more detailed example of the SBE (106) is seen for separating multiple conductive (e.g., metal) pipes residing in a ground location (e.g., a borehole or ditch). In the illustration, a first SBE (102a) has a circular inner arc (802) (also referred to as a “SCIA”) of less than 180 degrees, a first straight-tapered end (804a) and a second straight-tapered end (804b). Also seen is second SBE (102b) having substantially the same circular arc (802) as the first SBE and being of less than 180 degrees. As seen when the first and second SBEs (102a) and (102b) are positioned radially-opposite each other on the circular arc, the SBEs will not touch on at least one side. In some examples, as illustrated in FIG. 7A, they do not touch on either side. In some alternative examples, SBEs (102a) and (102b) are connected (e.g., by a hinge (806) but still do not touch on both sides when positioned along the arc (802). A bonding agent (sometimes referred to as an adhesive) is applied to the inner surfaces of the first and the second elements, as described elsewhere in this document, and means for positioning, under radial pressure, the first SBE (102a) and the second SBE (102b) around a pipe (106a) are provided, substantially opposed to each other. As illustrated, pipe (106a) has an outer diameter about the same or slightly smaller as the SCIA of SBE (102a) and EIE (102b).

Referring again to FIG. 3B, in at least one example, a means for positioning (e.g., a set of straps or bands 402a-402f) is used (in at least one example, zip-ties). In many such examples, the means for positioning is applied at substantially ambient temperature, avoiding undesirable shrink wrap, which tends to peel and clog rollers and boreholes in narrow environments. The ambient-air positioning also avoids risk to pipe (106a) that may be caused by application of heat to a shrink-wrap or other heated positioner. Further, the illustrated bands, do not axially extend beyond the straight-tapered-ends of SBE (102a) or SBE (102b), are positioned and arranged to exert a radial force on SBE (102a) or SBE (102b) that is less than the minimum bending force of either the first or the second SBEs. This prevents the tapered ends of the SBEs from creeping up, which would cause binding and damage to SBE (102a) or SBE (102b) in close environments. At the same time, bands limit axial movement of SBE (102a) or SBE (102b) by being constrained, for example, in channels (404a-40df) molded into SBEs (102a) and (102b). In at least one example, the shoulders of channels (404a-404f) are about 90 degrees. In other examples, the constraint comprises other ridges, tapers, or other structures that prevent bands or other means for positioning from axial slippage. The bands holding SBEs (102a) and (102b) against the pipe (106a) as the bonding agent cures to the pipe surface/coating. In at least one example, the bonding agent is applied to substantially all (for example, 90% or more) of the interior surface of at least one of the first SBE (102a) and second SBE (102b). In some examples, elements comprise a polyurethane of hardness 90 Shore A. Other acceptable materials include non-electrically-conductive materials that will occur to those of skill in the art without further elaboration.

What is claimed is:

1. A device for separating multiple metal pipes through a common borehole, the device comprising:
a. a first electrically insulating element having an inner arc of less than 180 degrees, a first straight-tapered end and a second straight-tapered end;
b. a second electrically insulating element having the same circular arc as the first electrically insulating element, the first and second electrically insulating elements being positioned radially-opposite each other on the inner arc and defining at least one gap between the elements;
c. a bonding agent applied to the inner surfaces of the first and the second elements;
d. means for positioning the first and second elements at ambient temperature with an axial length terminating between the straight-tapered-ends when the elements are under radial pressure and confined in axial movement by at least one shoulder of each of the first and second elements.

2. A device as in claim 1, wherein said shoulder of each of said first and said second elements comprises 90 degrees.

3. A device as in claim 1, wherein said shoulder of each of said first and said second elements comprises 45 degrees.

4. A device as in claim 1, wherein said means for positioning radial pressure applicators.

5. A device as in claim 4, wherein said radial pressure applicators comprise binding strips holding the first and second elements against the pipe as the bonding agent cures to the pipe surface.

6. A device as in claim 1, wherein said bonding agent is applied to substantially all of an inner surface of at least one of said first and second elements.

7. A set of multiple metal pipes residing a common borehole, the bundle comprising:
a first metal pipe;
a second metal pipe located parallel with the first metal pipe;
a spacer between the first metal pipe and the second metal pipe;
wherein the spacer comprises:
a. a first electrically insulating element having an inner arc of less than 180 degrees, a first straight-tapered end and a second straight-tapered end;
b. a second electrically insulating element having the same circular arc as the first electrically insulating element, the first and second electrically insulating elements being positioned radially-opposite each other on the inner arc and defining at least one gap between the elements;
c. a bonding agent applied to the inner surfaces of the first and the second elements; and
d. means for positioning the first and second elements at ambient temperature with an axial length terminating between the straight-tapered-ends when the elements are under radial pressure and confined in axial movement by at least one shoulder of each of the first and second elements.

8. A set of multiple metal pipes as in claim 7, the set comprising a bundle of metal pipes positioned beside each other.

9. A set of multiple metal pipes as in claim 7, the set comprising a set of metal pipes positioned with at least one metal pipe inside another metal pipe.

10. A system for installing multiple pipes in a borehole, the system comprising:
a. means for installing a straight-tapered bumper element around a first pipe;
b. means for pulling the first pipe and a second pipe passed a pipe roller, the tapered bumper element preventing the first and second pipes from touching during the pulling;
c. means for preventing bouncing of pipes in the pipe roller with the taper.

11. A system as in claim 10 wherein said means for installing a straight-tapered bumper element comprises:
a. bands applying a radial force against bumper elements disposed opposite each other on a pipe and
b. bonding agent positioned between the bumper elements and the pipe.

12. A system as in claim 10 wherein said mains for pulling the first pipe and the second pipe comprises a horizontal directional drilling system.
